(19) United States
(12) Patent Application Publication
(10) Pub. No.: US 2003/0110478 A1
(43) Pub. Date: Jun. 12, 2003

(54) Portable run-time code synthesis in a caching dynamic translator

(76) Inventors: Evelyn Duesterwald, Somerville, MA (US); Giuseppe Desoli, Watertown, MA (US); Vasanth Bala, Sudbury, MA (US)

Correspondence Address: HEWLETT-PACKARD COMPANY, Intellectual Property Administration, P.O. Box 272400, Fort Collins, CO, 80527-2400, US

(21) Appl. No.: 09/989,180

(22) Filed: Nov. 21, 2001

(51) Int. Cl. G06F 9/45

(52) U.S. Cl. 717/137

(57) ABSTRACT

A method of producing a caching dynamic translator with portable run-time code synthesis includes programming hardware independent replacement functions in a high level programming language for the caching dynamic translator, and compiling the hardware independent replacement functions to produce hardware dependent computer executable replacement functions.

### FIELD OF THE INVENTION

This invention relates generally to computer systems and more specifically to a portable run-time code synthesis mechanism in a translator, particularly in a caching dynamic translator.

### BACKGROUND

As is generally known, computers are used to manipulate data under the control of software. Modern digital computers typically include components such as one or more microprocessors, random-access memory, storage devices such as hard disks, CD-ROM and floppy drives, and other input/output devices such as a monitor, keyboard, and mouse. Computers, in particular multi-purpose computers, are controlled by operating system software, which in turn executes user application software. Both operating system software and user application software are written to execute on a given type of computer hardware. That is, software is written to correspond to the particular instruction set that the processor in the computer recognizes and can execute.

Computers widely available today have many different architectures, each with their own instruction set, such as the X86 architecture of the Intel Corporation, the PA-RISC architecture of the Hewlett-Packard Company, the Itanium architecture of the Intel Corporation and the Hewlett-Packard Company, the Power PC® architecture of Motorola, IBM, and Apple, or the Alpha® and VAX® architectures of the Digital Equipment Corporation. Furthermore, these architectures are upgraded and modified with each new generation of microprocessors, generally providing additional processing power.

Unfortunately, as computer hardware is upgraded or replaced, the preexisting software, which was created at enormous cost and effort, may be rendered obsolete. Since the software was written for a previous instruction set architecture, it generally contains instructions which the new computer hardware does not understand. Not only does this require a huge capital expenditure to update or replace the software, but the new software often can require retraining of the users. For example, at the consumer level of computer systems, Apple Computer, Inc. has produced computers with processors including the 6802 microprocessor from MOS Technologies, the 6502A from Synertek, the MC68000 family of processors from Motorola, and the PowerPC processors from Motorola, IBM, and Apple, each with different instruction set architectures. Each time a new computer system appeared with a different instruction set, the previous software became obsolete and millions of users had to learn to use new software. More recently, in large computing systems such as banking computer systems, a packaged solution of computer hardware and custom programmed software with a relatively long life expectancy may often be provided by a single vendor. When the system is upgraded, a new packaged solution with different computer hardware and new custom software replaces the previous solution. This need to replace software whenever computer hardware is replaced is enormously expensive, both in capital costs and training costs for users.

Various responses to this problem are currently used, such as maintaining obsolete computer hardware far beyond its design life expectancy. Particularly in massive critical systems, a great deal of money and effort is spent maintaining outdated computer hardware in order to avoid updating software, both because of the expense of updating the software and the inevitable operating errors due to bugs in the new software. For example, attempting to upgrade computer hardware for air traffic control systems has required decades of effort. Clearly, however, maintaining obsolete computer hardware is not an ideal solution, and a need remains for a better way to upgrade hardware and maintain existing software.

Another existing response to this problem, and perhaps the most common, is simply to rewrite the software each time the computer hardware is upgraded. However, as software becomes larger and more complex, the cost of rewriting increases. Furthermore, frequent changes in software interfaces tend to frustrate and alienate users.

Software developers have increasingly turned to programming user applications in high level languages like C++. The high level program code (source code) is then compiled by a compiler program to convert it to machine language binary programs (object code) targeted at a specific instruction set. An attempt is made to program the high level program code to be hardware independent, so that the same code can be compiled by different compilers for different types of computer hardware. This response to the problem is moderately successful, since compilers for each instruction set are created each time a new architecture appears. However, this response does not address the issue of changing peripherals or other components in computer systems. For example, although much of the program code may compile on a new compiler without problems, hardware specific program code, i.e., code for controlling specific hardware, such as network or communication circuitry, has to be rewritten even if it is in a high level language. Also, it is often necessary to modify even high level program code somewhat before recompiling with a new compiler, since compilers tend to have different compiler directives or syntax. Therefore, it is desirable to minimize the number of programs that have to be individually recompiled to port them to new hardware platforms.

Another existing response to this problem is to write computer programs in a hardware independent language, such as JAVA® of Sun Microsystems, Inc. However, hardware independent languages are typically quite slow, as they are executed by an emulation program or interpreter which creates a virtual processor on the physical computer hardware. Thus, hardware independent languages generally do not provide any computer instructions which are native to the target computer system, making all execution relatively slow. Furthermore, a different interpreter must be created for each instruction set on which JAVA® software is to run.

Translators have been written for translating computer software from one particular instruction set to another. However, translators have typically been limited to point-to-point solutions, necessitating a new translator for each legacy architecture. Typical translators read the opcodes of the legacy software and explicitly generate translated code which is native to the new hardware. The translators are therefore custom programmed to read code for a particular source instruction set and to produce code for a particular target instruction set. This code generation portion of a translator is the most hardware dependent portion of the translator. Therefore, manually porting translators between instruction sets is extremely labor intensive.

A need therefore exists for a system for reusing legacy computer software on incompatible or updated computer hardware. A further need exists for a mechanism to simplify porting software translators from one target computer system to another. A further need exists for a system to render software translators more hardware independent.

### SUMMARY

The inventors have met these and other needs by providing a portable run-time code synthesis mechanism for translators, and in particular for a caching dynamic translator. The code synthesis portion of a translator is made up of high level functions corresponding to operation codes (opcodes) from the binary executable program to be translated. These high level functions in the translator are programmed in a hardware independent manner to the extent possible. The translator, including the code synthesis portion, is compiled for execution on the target system using a compiler designed for the target system. Thus, the compiler generates the hardware dependent code in the translator. During the translation process, the translator reads source opcodes and replaces them with the compiled functions making up the code synthesis portion of the compiler. The replacement translated code, made up of compiled functions in the translator, can then be executed or optimized, as desired. The translation can be performed at run-time, meaning that the legacy code is translated dynamically while it is executed, or it can be performed statically before the legacy code is executed. The translator is preferably a caching dynamic translator, which translates, caches, then executes the program at run-time.

### BRIEF DESCRIPTION OF THE DRAWING

Illustrative and presently preferred embodiments of the invention are shown in the accompanying drawing, in which:

FIG. 1 is an exemplary block diagram illustrating a prior art computer system suitable for creating or operating a caching dynamic translator with portable run-time code synthesis; and

FIG. 2 is an exemplary flow chart illustrating a method of producing a caching dynamic translator with portable run-time code synthesis.

### DESCRIPTION OF THE PREFERRED EMBODIMENTS

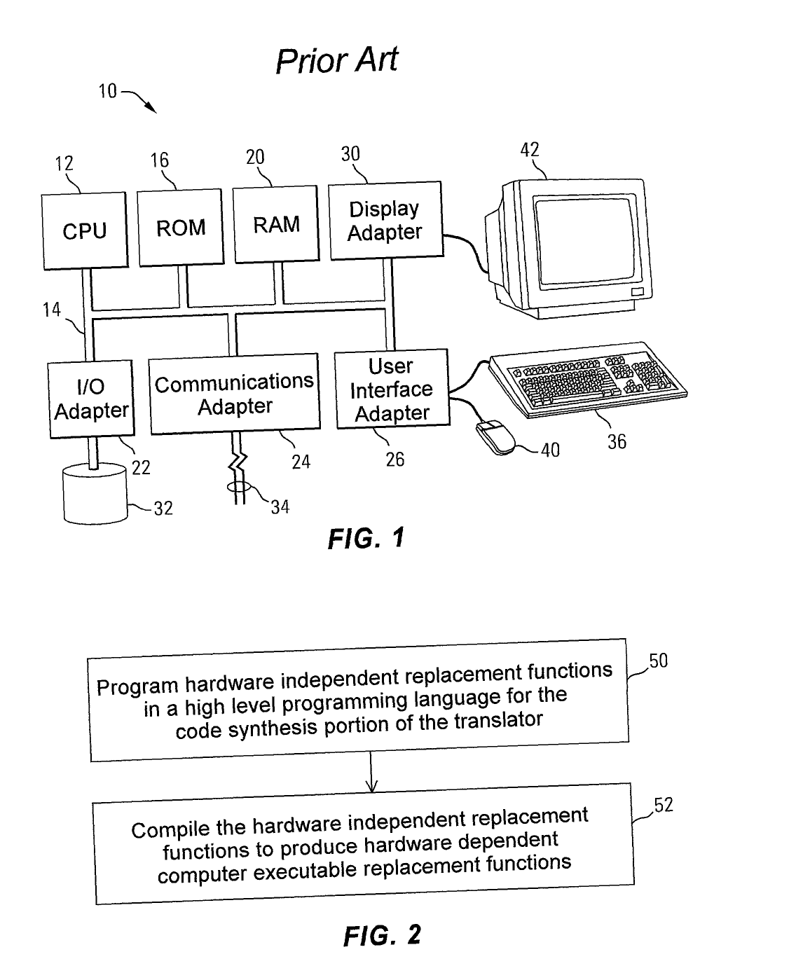

A typical computer system which may be used to implement portable run-time code synthesis in a caching dynamic translator is illustrated in the block diagram of FIG. 1. A computer system 10 generally includes a central processing unit (CPU) 12 connected by a system bus 14 to devices such as a read-only memory (ROM) 16, a random access memory (RAM) 20, an input/output (I/O) adapter 22, a communications adapter 24, a user interface adapter 26, and a display adapter 30. Data storage devices such as a hard drive 32 are connected to the computer system 10 through the I/O adapter 22. In operation, the CPU 12 in the computer system 10 executes instructions stored in binary format on the ROM 20, on the hard drive 32, and in the RAM 16, causing it to manipulate data stored in the RAM 16 to perform useful functions. The computer system 10 may communicate with other electronic devices through local or wide area networks (e.g., 34) connected to the communications adapter 24. User input is obtained through input devices such as a keyboard 36 and a pointing device 40 which are connected to the computer system 10 through the user interface adapter 26. Output is displayed on a display device such as a monitor 42 connected to the display adapter 30.

A translator with a portable run-time code synthesis mechanism, which can be executed on a computer system 10, can be ported to new computer systems with relative ease and simplicity. As computer systems with new instruction sets are designed, one of the first software tools which is created for the new systems is a compiler. Therefore, by writing the code synthesis mechanism of a translator in a high level language to be as hardware independent as possible, the translator can be recompiled for new hardware instruction sets or target computer systems, rather than manually reprogramming the hardware dependent code synthesis portion of the translator. Thus, it is the compiler for the new target computer system which generates much of the hardware dependent code in the translator, and the translator itself remains hardware independent and portable to a great degree.

The code synthesis mechanism of the translator consists in large part of replacement functions which are a translation of the possible operation codes (opcodes) from the legacy computer system. A typical opcode consists of a two digit hexadecimal number corresponding to an operation defined in the instruction set, such as an ADD operation. The opcode may be followed by one or more operands, or parameters to the operation, such as an indication of two numbers to add. To produce a translation for a sequence of opcodes from the input binary, the translator uses the function definitions as templates in a cut-and-paste fashion. That is, the translation is incrementally produced by pasting together the native code of the translator itself, consisting of the functions defined as replacements for the legacy opcodes.

The translator reads the opcode and operands, if any, and substitutes the appropriate function from the code synthesis portion of the translator, effectively pasting in part of the translator in the place of the source code. The operands, if any, are used as the parameters to the replacement function. The replacement functions are preferably designed to accept the operands as they appear in the source code, although the translator could alternatively do some conversion or modification of the operands, such as type conversion or data width adjustments. The final translation consists then of a sequence of pasted function bodies. To obtain full portability, the translator does not perform any further transformations of the code. Alternatively, the translator can perform optimization passes on the sequence of pasted function bodies to tune the synthesized code.

The term “function” as it applies to replacement functions which make up the code synthesis mechanism of a translator refers to any code segment that is used to replace legacy opcodes and operands or any other legacy code segment of a computer program to be translated. In this context, the term “function” does not necessarily refer to a standard function or subroutine that is called and returns after execution, but could be a code segment whose entry and exit is controlled by the translator. The translator with portable run-time code synthesis translates computer program code from one instruction set to another, where the term instruction set refers to any type of instruction set, such as a central processing unit (CPU) instruction set, a virtual machine instruction set like Java® bytecodes, or any other type of instruction set.

There is preferably one function defined in the translator for each opcode in the legacy system, although this may be varied as desired. For example, there may be several functions defined for each legacy opcode depending upon the different possible number of operands associated with each opcode, and the different possible data types of the operands associated with each opcode. The determination of whether to define a single function for each legacy opcode, or multiple functions for each legacy opcode, or even a single function for multiple legacy opcodes, is a design choice that involves code size and execution speed. In a translator, it is generally preferable to increase execution speed at the cost of code size. Therefore, the functions should be defined to minimize the time required both to replace the legacy opcode with the replacement function, and the time required to execute the replacement function. The time required to replace the legacy opcode with the replacement function is affected, for example, by the difficulty and manner with which a replacement function is identified for a given opcode, and the amount of conversion required on the parameters to the replacement function, if any. To avoid type conversions on the parameters to the replacement function, multiple functions may be associated with each legacy opcode, one for each possible parameter group. These multiple functions may be individually named and explicitly called, or may be commonly named to create an overloaded function. Identifying the proper function to call, or resolving the overloaded function, slows the translation and execution process.

There are many considerations such as these when implementing the translator with portable run-time code synthesis. However, they are considerations which are frequently addressed by those skilled in the art of programming, and the chosen solutions depend greatly upon the design goals. Therefore, the design of the replacement functions will not be described in detail herein, except that they are written in high level programming languages to be as hardware independent as possible, so that the burden of producing hardware dependent code is shifted from the programmer of the translator to the programmer of the compiler used to compile the translator.

The translator using portable run-time code synthesis therefore remains very portable. The opcode functions whose native code implementations are used during the translation synthesis are specified in a high level language, such as C++. Thus, the compiler that is used to compile the translator code provides the native hardware dependent code generation. The translator does not even need to know what the native language it is translating to actually is. This provides great benefits over the conventional code generation approach in which the translator is explicitly programmed with the native code for each opcode. This code generation portion of a conventional translator is the most hardware dependent portion, requiring significant porting effort when moving to a different target computer system. Therefore, the translator with portable run-time code synthesis can be easily used for multiple target computer system without requiring a large porting effort for each new target computer system.

The translator with portable run-time code synthesis is preferably a caching dynamic translator. A dynamic translator is one which translates a computer program while the computer program is being executed. That is, the translator runs concurrently with the computer program to be translated. The translator intercepts or reads instructions from the computer program to be translated and provides the translation for these instructions. The translated instructions can then be executed immediately. Dynamic translation provides the benefit of avoiding the step of translation before execution. Dynamic translators can also produce faster code in some cases, since the translated code can be optimized based on its characteristics during execution which are not known prior to execution. The translation produced by a dynamic translator, or a portion of the translation, can also be stored on the computer system to speed up or eliminate the translation process the next time the computer program is executed.

The translated instructions provided by the dynamic translator can also be immediately stored in a cache during the translation/execution process, making the dynamic translator a caching dynamic translator. For example, as a translation is created for a series of legacy instructions, it can be stored in a cache as well as executed. The next time the caching dynamic translator encounters the same series of legacy instructions, it can immediately execute the translation stored in the cache, rather than retranslating them. Note that the cache employed in a caching dynamic translator is not a typical memory cache, but requires a number of control points allowing the translator to jump between execution of newly translated code and cached translated code. The structure and design of dynamic program caches is well known and will not be described in detail herein.

In one preferred embodiment, the caching dynamic translator is part of a dynamic execution layer such as that described in U.S. patent application Ser. No. 09/924,260 for a “Dynamic Execution Layer Interface for Explicitly or Transparently Executing Application or System Binaries,” filed Aug. 8, 2001, which is incorporated herein by reference for all that it discloses. The dynamic execution layer provides several services for the caching dynamic translator, such as control of a legacy computer program to intercept and read legacy opcodes, cache management, controlled execution of translated instructions from the cache, etc, greatly simplifying the caching dynamic translator.

The dynamic execution layer described in the above referenced patent application is a software layer that executes between a computer program and the computer hardware in order to transform the program. The dynamic execution layer intercepts instructions from the executable image of the program before they are executed by the hardware and transforms them, such as to optimize them, provide virtual support for missing hardware, or any number of desirable tasks. The dynamic execution layer may also cache transformed code segments to improve execution speed of code segments which are repeatedly executed. When used with a caching dynamic translator, the dynamic execution layer preferably translates the instructions before they are otherwise transformed, cached, and executed by the dynamic execution layer.

The dynamic execution layer assembles groups of instructions to be transformed, cached, and executed. The dynamic execution layer identifies code traces from the legacy computer program, or sequences of instructions generally beginning at the instruction after a backward taken branch and continuing to the next backward taken branch. The individual instructions, or opcodes, are preferably translated before traces are identified, although the instructions in a trace could alternatively be translated after the trace is identified. The dynamic execution layer stores traces in the cache as fundamental groups of instructions which can be repeatedly executed from the cache without repeatedly translating and transforming them.

Executing a series of replacement functions which were written as hardware independent high level functions, then compiled, is probably not as efficient as a conventional translator which is carefully programmed in a hardware dependent manner to produce an efficient translation. However, by using a caching dynamic translator, particularly coupled with a dynamic execution layer as described above, the replacement functions can be dynamically optimized as well. Thus, the dynamic translation becomes efficient, and the translator remains portable.

In an alternative embodiment, the caching dynamic translator can be a standalone caching dynamic translator. In this case, the caching dynamic translator must provide many of the services discussed above which the dynamic execution layer provides. For example, the standalone caching dynamic translator must control execution of the legacy computer program to extract instructions to be translated. The standalone caching dynamic translator must also provide caching services and any other desired transformation and optimization services. The standalone caching dynamic translator must also control execution of instructions from the cache.

The caching dynamic translator with portable run-time code synthesis may also be based upon an emulator, a program which imitates or emulates the function of a legacy computer system in a similar manner. An emulator with portable run-time code synthesis in this case performs the same basic function as a translator, by replacing instructions from the legacy computer program with replacement code segments which emulate the specific instruction being replaced. Emulators generally do not produce a translation of a program which can be stored and run natively. Rather, emulators execute legacy computer programs by constantly producing imitation or emulated instructions which are immediately executed on target hardware, with no optimization. In this case, the caching dynamic translator can be based upon an emulator with portable run-time code synthesis, that is, the replacement functions in the emulator for legacy opcodes are programmed in a high level language to be hardware independent. The high level replacement functions in the emulator capture the semantics of the original legacy instructions, but are not at this point mapped to the target computer hardware. When the emulator is compiled, it is the compiler that maps the function to the target hardware, making it hardware dependent. To base the caching dynamic translator on this emulator, the translator intercepts replacement functions for legacy opcodes from the emulator and adds them to a code cache. The next time the emulator encounters the same series of legacy opcodes, the translator executes the replacement functions from the code cache rather than allowing the emulator to continue emulating the legacy opcodes.

Alternatively, the translator may store references to the emulator's replacement functions in the code cache, instead of copying the replacement functions directly to the code cache. Thus, rather than having a series of functions in the code cache, the translator stores a series of function calls in the code cache, which call the replacement functions in the emulator.

To summarize the creation of a caching dynamic translator with portable run-time code synthesis, hardware independent replacement functions are programmed 50 in a high level programming language for the caching dynamic translator, and the hardware independent replacement functions are compiled 52 to produce hardware dependent computer executable replacement functions.

Exemplary program code for implementing portable run-time code synthesis in a caching dynamic translator will now be described. Much of the code is explained by comments found throughout the code. Comments are surrounded by “/* . . . */” symbols with the body of each comment italicized to further distinguish comments from code. In addition, some description follows each section. The code begins with macro definitions and global variable declarations.

#define NUM_EMULATED_REGS 4 /* System with 4 regs */
#define EMULATED_MEM_SIZE (1 << 20) /* 1 Mb memory */
unsigned int pc, regs[NUM_EMULATED_REGS];
unsigned char ram[EMULATED_MEM_SIZE];
/* REG function or macro that assigns or retrieves a
value to/from a given emulated register in a virtual
machine */
#define REG(x) reg[x]
/* LOAD/STORE functions or macros that read/store a value
from/to emulated address x in a virtual machine */

| | |
|---|---|
| #define LOAD(x) | ram[x] |
| #define STORE(x,v) | ram[x] = v |

```
/* These variables will be used by the opcode_functions
to store read operand register indexes */
int dst_reg, src1_reg, src2_reg;
/* High level function definitions */
void emul_add( )
{
  REG(dst_reg) = REG(src1_reg) + REG(src2_reg);
}
void emul_sub( )
{
  REG(dst_reg) = REG(src1_reg) − REG(src2_reg);
}
void emul_mul( )
{
  REG(dst_reg) = REG(src1_reg) * REG(src2_reg);
}
void emul_mov( )
{
  REG(dst_reg) = REG(src1_reg);
}
void emul_load_indirect( )
{
  REG(dst_reg) = LOAD(REG(src1_reg));
}
void emul_store_indirect( )
{
  STORE(REG(dst_reg), REG(src1_reg));
}
```

The function definitions above are exemplary high level functions which are used to replace opcodes from the program to be translated. Additional high level functions would be defined according to the opcodes in the legacy architecture. Note that the function definitions use global variables to access operands, rather than parameters. The exemplary code shown herein can be adapted as desired by skilled programmers, particularly those skilled in design of translators and dynamic execution environments.

/* This table stores the pointers to the functions
emulating the various opcodes */
void *opcode_emul_functions[NUM_OPCODES] = {

&emul_add,
&emul_sub,
&emul_mul,
&emul_mov,
&emul_load_indirect,
&emul_store_indirect,
. . . .
};

/* Functions for storing constant values into register
indexes for opcode emulation functions */
void store_dst_0( ) { dst_reg = 0; };
void store_dst_1( ) { dst_reg = 1; };
. . . .
void store_src1_0( ) { src1_reg = 0;};
void store_src1_1( ) { src1_reg = 1;};
. . . .
void store_src2_0( ) { src2_reg = 0;};
void store_src2_1( ) { src2_reg = 1;};
. . . .

The functions above are used to store a constant value into one of the register indexes used by the opcode emulation functions. These functions would preferably be written as small assembly fragments generated in place for the host platform which perform the same function as the exemplary C functions above.

```
/* This table stores the pointers to the functions for
storing constant values into register indexes */
void *dst_set_functions[NUM_REGISTERS] = {
  &store_dst_0,
  &store_dst_1,
  . . .
  };
void *src1 set functions[NUM_REGISTERS] = {
  &store_src1_0,
  &store_src1_1,
  . . .
  };
void *src2_set_functions[NUM_REGISTERS] = {
  &store_src2_0,
  &store_src2_1,
  . . .
  };
/* Get the next instruction to translate */
unsigned char get_instruction(unsigned int addr)
{
  return LOAD(addr);
}
    The get_instruction function retrieves the next
instruction from emulated memory in the virtual machine,
for example the next bytecode instruction if the
instruction set being emulated is composed of bytecodes.
/* Retrieve opcode */
#define GET_OPCODE(inst)
      ((inst&OPCODE_MASK) >> OPCODE_SHIFT)
    The get_opoode macro retrieves the opcode from an
instruction.
/* The following macros retrieve operands from a
bytecode with the following simple encoding:
(opcode | dst | src1 | src2) */
#define GET_DST_REG(inst) ((inst&DST_MASK)>>DST_SHIFT)
#define GET_SRC1_REG(inst) ((inst&SRC1_MASK)>>SRC1_SHIFT)
#define GET_SRC2_REG(inst) ((inst&SRC2_MASK)>>SRC2_SHIFT)
/* Simplified exemplary function to increment a program
counter */
void increment_program_counter( ) {
  pc = pc + 1;
}
/* The following functions deal with the actual code
translation */
/* Emit a prolog (e.g. to load operands for the opcode
emulation functions) */
void emit_prolog(unsigned char instruction)
{
  switch(GET_OPCODE(instruction)) {
case 0: /* add */
case 1: /* sub */
case 2: /* mul */
case x: /* Any opcodes with 1 dest. & 2 sources */
    append_code(dst_set_functions[GET_DST_REG(inst)]);
    append_code(src1_set_functions[GET_SRC1_REG(inst)]);
    append_code(src2_set_functions[GET_SRC2_REG(inst)]);
    break;
  case 3: /* mov */
  case 4: /* load indirect */
  case 5: /* store indirect */
  case y: /* Any opcodes with 1 dest. and 1 source */
    append_code(dst_set_functions[GET_DST_REG(inst)]);
    append_code(src1_set_functions[GET_SRC1_REG(inst)]);
    break;
  case z: /* Any opcodes with 1 dest. and 1 source */
    append_code(dst_set_functions[GET_DST_REG(inst)]);
    break;
  default: /* Any opcodes with 0 dest. and 1 source */
    break;
  }
}
```

The append_code function (which is not listed herein) is a simplification of the DELI API facility for emitting code fragments, which is described in the patent application previously incorporated herein entitled “Dynamic Execution Layer Interface for Explicitly or Transparently Executing Application or System Binaries.” The append_code function places code into a code buffer for either calling a given function or placing the function inline. The code placed in the code buffer by the append_code function will later be emitted into a dynamic execution layer code cache through the deli_emit function.

/* This function translates one instruction */
void translate_new_instruction(unsigned int

translation_pc)

```
{
  unsigned char inst = get_instruction(translation_pc);
  emit_prolog(inst);
  append_code(opcode_emul_functions[GET_OPCODE(inst)]);
  append_code(&increment_program_counter);
}
```

At this point the translate_new_instruction function can be used as a building block to write a translator or emulator using portable run-time code synthesis.

emulator_translator( ) {

unsigned int translation_pc;
while(1) {

deli_exec(pc); /* Run temporarily in code cache */
translation_pc = pc;
/* Run in the next loop translating instructions and
* placing them in a code buffer until a basic block
* has been translated, then execute it. The
* stop_translation function returns a true value
* to continue translating instructions until enough
* has been translated to warrant execution */
while(stop_translation( )) {

translate_new_instruction(translation_pc);
translation_pc += 1;
}

/* Now emit the translated code into the code
* buffer using the deli_emit function, so that
* the next time through the while(1) loop
* it will be executed by the deli_exec function */
deli_emit( );
}

}

As mentioned above, the functions above which reference the Dynamic Execution Layer Interface (DELI) are described in the patent application previously incorporated herein entitled “Dynamic Execution Layer Interface for Explicitly or Transparently Executing Application or System Binaries” which describes a caching dynamic execution environment which facilitates caching dynamic translation. However, portable run-time code synthesis in a caching dynamic translator is not limited to any particular type of caching dynamic translator.

A short instruction sequence will now be described as it may be translated by the exemplary program code above for implementing portable run-time code synthesis in a caching dynamic translator, as follows:

mem address

| | | |
|---|---|---|
| 0x0 | load | $r1 = [$r3] |
| 0x1 | load | $r2 = [$r4] |
| 0x2 | add | $r1 = $r1,$r2 |
| 0x3 | mul | $r1 = $r1,$r1 |
| 0x4 | store | [$r3] = $r1 |

The instruction sequence above computes (a+b)*(a+b), where a and b are operands in memory locations pointed by registers r3 and r4 respectively on entry. The instruction sequence stores the results in the location pointed to by r3, similar to the operation of a stack machine, e.g. Java.

The exemplary program code above for implementing portable run-time code synthesis in a caching dynamic translator would produce the following inlined code from the instruction sequence above:

| | |
|---|---|
| dst_reg = 1 | \|---------------> emitted by emit_prolog |
| src1_reg = 3 | \| |

reg[dst_reg] = ram[src1_reg] |-> emitted by

translate_new_instruction

pc = pc + 1
dst_reg = 2
src1_reg = 4
reg[dst_reg] = ram[src1_reg]
pc = pc + 1
dst_reg = 1
src1_reg = 1
src1_reg = 2
reg[dst_reg] = reg[src1_reg] + reg[src2_reg]
pc = pc + 1
dst_reg = 1
src1_reg = 1
src2_reg = 1
reg[dst_reg] = reg[src1_reg] * reg[src2_reg]
pc = pc + 1
dst_reg = 3
src1_reg = 1
ram[reg[dst_reg]] = reg[src1_reg]

Note that the emission of “pc=pc+1” is only necessary if the instruction set has PC-relative instructions (e.g. branch or memory).

The resulting translated code sequence below is produced by applying basic optimizations such as constant propagation and dead code removal, but it could be optimized further if desired (e.g. with redundant load elimination, register promotion, etc.).

reg[1]=ram[reg[3]]

reg[2]=ram[reg[4]]

reg[1]=reg[1]+reg[2]

reg[1]=reg[1]*reg[1]

ram[reg[3]]=reg[1]

From the translated code sequence above, the following instructions would result, where t's are temporary (possibly stored in a register in the host machine):

t3=reg[3]

t1=ram[t3]

t2=ram[reg[4]]

t1=t1+t2

t1=t1*t1

ram[t3]=t1

Even if optimizations are not performed on the translated fragment, it will still be much more efficient that a mere emulation of the original code, for which an emulator would have to perform the extra operations of fetching the opcodes from memory, decoding them to extract opcodes and operands, and invoking the proper function to do the emulation (with the additional overhead of issuing function calls). Thus, portable run-time code synthesis in a caching dynamic translator provides an efficient but portable mechanism for executing legacy program code.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of producing a translator for computer executable instructions, the method comprising:
programming replacement code segments in said translator in a high level programming language, wherein said translator is for translating computer executable program code from code for a first instruction set to code for a second instruction set, said replacement code segments for replacing portions of said code for a first instruction set; and
compiling said replacement code segments in said translator to create computer executable instructions.

2. The method of claim 1, wherein programming replacement code segments in said translator in a high level programming language comprises programming hardware independent code segments.

3. The method of claim 1, wherein programming replacement code segments in said translator in a high level programming language comprises programming replacement functions in said translator.

4. The method of claim 1, wherein said portions of said code for a first instruction set comprise operation codes.

5. The method of claim 1, wherein said translator comprises a dynamic translator.

6. The method of claim 1, wherein said translator comprises a caching dynamic translator in which one or more of said replacement code segments are stored in a cache during translation so that said replacement code segments can be executed repeatedly without repeatedly replacing said portions of said code for a first instruction set during a single translation process.

7. The method of claim 1, wherein programming said replacement code segments in said translator in said high level programming language comprises programming replacement code segments in the C programming language.

8. The method of claim 1, wherein programming said replacement code segments in said translator in said high level programming language comprises programming replacement code segments in the C++ programming language.

9. The method of claim 1, wherein compiling said replacement code segments in said translator to create said computer executable instructions comprises processing said replacement code segments with a compiler designed to create computer executable instructions for said second instruction set.

10. A method of programming a translator, comprising:
writing replacement functions in said translator in a high level programming language to simulate instructions in a computer program to be translated; and
compiling said translator to convert said replacement functions written in a high level programming language to low level computer executable instructions, so that said translator can replace said instructions in a computer program to be translated with said low level computer executable instructions for said replacement functions.

11. The method of claim 10, wherein writing said replacement functions in said translator in a high level programming language comprises writing hardware independent replacement functions.

12. The method of claim 10, wherein said instructions in said computer program comprise opcodes.

13. The method of claim 10, wherein said translator comprises a dynamic translator.

14. The method of claim 10, wherein said translator comprises a caching dynamic translator in which one or more of said replacement functions are stored in a cache during a translation process so that said replacement functions can be executed repeatedly without repeatedly replacing said instructions in said computer program to be translated during said translation process.

15. The method of claim 10, wherein writing said replacement functions in said translator in said high level programming language comprises programming said replacement functions in the C programming language.

16. The method of claim 10, wherein writing said replacement functions in said translator in said high level programming language comprises programming said replacement functions in the C++ programming language.

17. A method of producing a caching dynamic translator with portable run-time code synthesis, comprising:
programming hardware independent replacement functions in a high level programming language for said caching dynamic translator; and
compiling said hardware independent replacement functions to produce hardware dependent computer executable replacement functions.

18. The method of claim 17, wherein compiling said hardware independent replacement functions comprises compiling said caching dynamic translator.
